(19) United States
(12) Patent Application Publication
(10) Pub. No.: US 2006/0095805 A1
(43) Pub. Date: May 4, 2006

(54) Suppression of sleep mode in a computing device via date/time windows

(76) Inventors: Paul J. Broyles, Cypress, TX (US); Patrick L. Gibbons, Magnolia, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/977,388

(22) Filed: Oct. 29, 2004

(51) Int. Cl. G06F 1/32

(52) U.S. Cl. 713/323

(57) ABSTRACT

Date/time windows may be defined to indicate periods during which a computing device should not enter a power conservation mode such as a sleep mode. If the sleep mode is requested while the device is operating, a determination may be made whether the current date/time falls within any of the windows. If the current date/time falls within any of the windows, then the request for sleep mode may be denied or suppressed and the device may continue to operate normally. Otherwise, the device may enter the sleep mode.

### FIELD OF THE INVENTION

This invention relates generally to power management in computing devices. More specifically, the invention relates to controlling transitions between power consumption modes in such devices.

### BACKGROUND

Many present-day computing devices are implemented with a “sleep mode” power management feature. The sleep mode is intended to conserve battery life and generally reduce power consumption when the computing device is not being used but is still powered on. For example, most laptop computers will enter sleep mode automatically after a predetermined period of idleness. While the computer is in the sleep mode, typically its hard disk does not spin and CPU activity may be slowed or halted. (Numerous variants of sleep mode are possible.)

Unfortunately, computing devices with the sleep mode feature sometimes enter sleep mode at inopportune times, such as during operating hours of an important business or service. In prior art computing devices, the only way to avoid such a mishap was to disable sleep mode entirely. But this solution defeated the purpose of an otherwise-beneficial power Management feature.

### SUMMARY OF THE INVENTION

In a computing device according to a preferred embodiment of the invention, date/time windows may be defined to indicate periods during which the device should not enter a power conservation mode such as a sleep mode. If the sleep mode is requested while the device is operating, a determination may be made whether the current date/time falls within any of the windows. If the current date/time falls within any of the windows, then the request for sleep mode may be denied or suppressed and the device may continue to operate normally. Otherwise, the device may enter the sleep mode.

### BRIEF DESCRIPTION OF THE DRAWINGS

FIG. 1 is a flow diagram illustrating a method for controlling power management mode transitions in a computing device according to a preferred embodiment of the invention.

FIG. 2 is a block diagram illustrating one example of a computing device configured to implement the method of FIG. 1 according to a preferred embodiment of the invention.

### DETAILED DESCRIPTION OF THE PREFERRED EMBODIMENTS

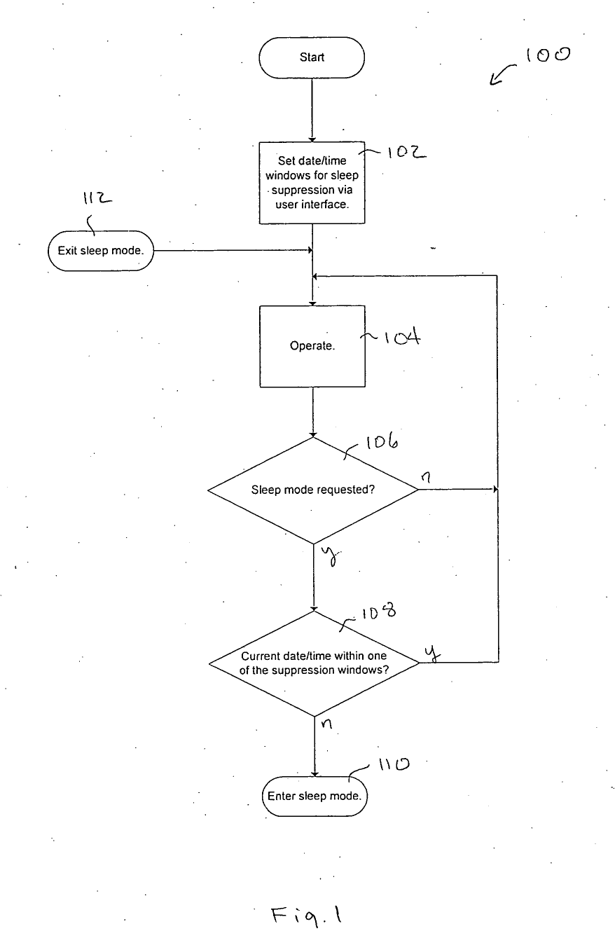

FIG. 1 illustrates a method 100 for controlling power management mode transitions in a computing device according to a preferred embodiment of the invention. In step 102, a user interface may be presented through which a human user may define one or more date/time windows during which the computing device should not enter a power conservation mode (hereinafter a “sleep mode”). The window definitions are stored in the computing device for later use. The windows may be defined using any reasonable semantics including, for example, definition variants in which the date is irrelevant and only the time of day is considered, and vice versa. In step 104, the computing device operates in a mode other than the sleep mode until, in step 106, a request is made within the computing device to enter the sleep mode. Such a request may take any reasonable form. For example, the request may be a notification generated by a subsystem after detecting a period of relative inactivity within the computing device or a period without any user input. If such a request or state is detected, then in step 108 the computing device determines whether the current date/time (indicated, for example, by an internal clock) falls within any of the previously-defined windows. If it is determined in step 108 that the current date/time does fall within one or more of the windows, then the request to enter the sleep mode is denied or the device otherwise avoids entering the sleep mode. But if the current date/time does not fall within any of the windows, then the device enters the sleep mode. Upon exiting the sleep mode (step 112), operation may resume at step 104.

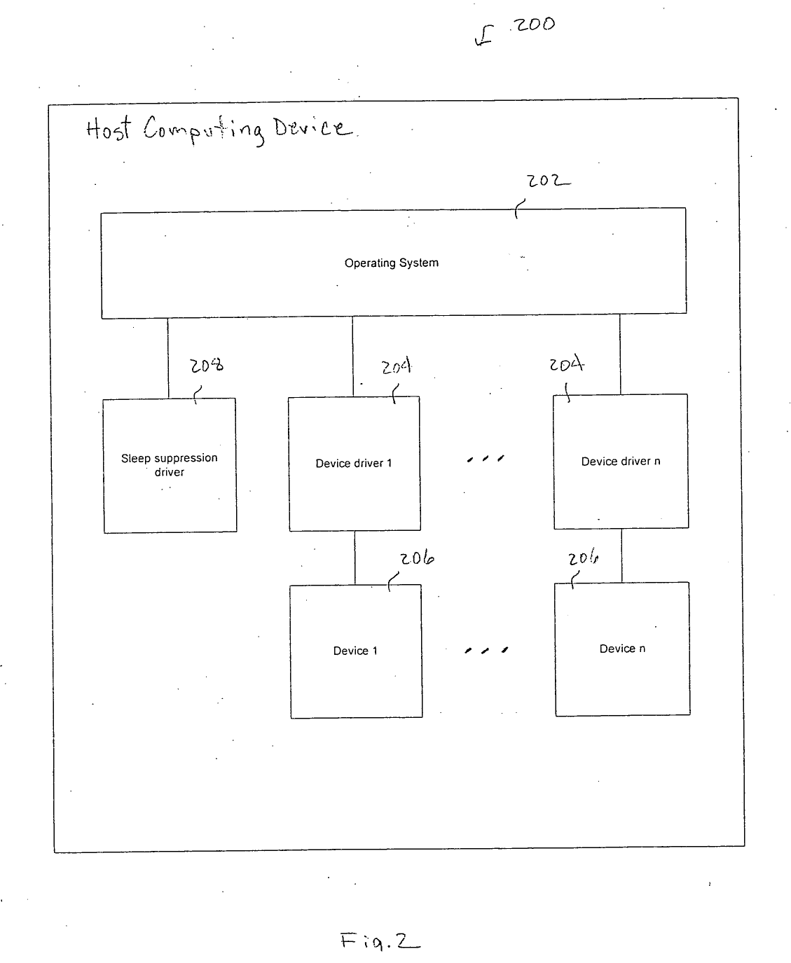

A computing device configured according to the invention may take any form. For example, the device may be a portable computing device such as a laptop computer. Moreover, suitable implementations for embodying the invention may vary according to the platform on which the invention is to be deployed. One illustrative example of such an implementation is given in FIG. 2.

In FIG. 2, a host computing device 200 includes an operating system 202 and (optionally) one or more device drivers 204. Device drivers 204 are for the purpose of controlling corresponding hardware devices 206. Computing device 200 also preferably includes a sleep suppression driver 208, which may or may not control a hardware device. Operating system 202 is configured to send a sleep notification to drivers 204, 208 when the operating system intends to cause computing device 200 to enter the sleep mode. But operating system 200 is also configured to avoid entering the sleep mode if one of the notified drivers indicates an objection to entering the sleep mode. Sleep suppression driver 208 is configured to register with the operating system to receive the sleep notification. Upon receipt of the sleep notification, driver 208 may perform the determination of whether the current date/time falls within one of the previously-stored windows during which the computing device 200 should not enter the sleep mode. If the current date/time falls within one of the windows, driver 208 indicates to the operating system an objection to entering the sleep mode. If desired, the functionality of sleep suppression driver 208 may be integrated with any of device drivers 204.

While the invention has been described in detail with reference to preferred embodiments thereof, the described embodiments have been presented by way of example and not by way of limitation. It will be understood by those skilled in the art that various changes may be made in the form and details of the described embodiments without deviating from the spirit and scope of the invention as defined by the appended claims. For example, in alternative embodiments, the above-described sleep-suppression functionality maybe integrated into operating system 202 such that the operating system may determine on its own whether the current date/time falls within one of the predetermined sleep suppression windows. Upon so determining, the operating system may simply avoid sending the sleep notification message to drivers 204. In still further alternative embodiments, the sleep-suppression functionality may be implemented in hardware rather than software such that the request to enter sleep mode may be suppressed even prior to reaching the operating system. These and other alternative embodiments are embraced within the scope of the following claims.

What is claimed is:

1. A method of controlling power management mode transitions in a computing device, comprising:
storing a definition of one or more date/time windows during which the computing device may not enter a sleep mode;
upon a request for entry into the sleep mode, determining whether a current date/time falls within any of the windows; and
if so, denying or suppressing the request; but
if not, entering the sleep mode.

2. The method of claim 1, wherein:
storing the definition of the one or more date/time windows comprises presenting a user interface through which a human user may indicate the date/time windows.

3. A computing device, comprising:
logic for storing a definition of one or more date/time windows during which the computing device may not enter a sleep mode;
logic for determining, upon a request for entry into the sleep mode, whether a current date/time falls within any of the windows, and if so, denying or suppressing the request, but if not, entering the sleep mode.

4. The computing device of claim 3, further comprising:
logic for presenting a user interface through which a human user may define the windows.

5. The computing device of claim 3, wherein:
the computing device is a portable computing device.

6. The computing device of claim 5, wherein:
the portable computing device is a laptop computer.

7. A computing device, comprising:
an operating system configured to send a sleep notification to one or more drivers when the operating system intends to cause the computing device to enter a sleep mode, but configured to avoid entering the sleep mode if one of the notified drivers indicates an objection to entering the sleep mode; and
a sleep suppression driver configured to register with the operating system to receive the sleep notification, arid further configured to:
determine, upon receiving the sleep notification, whether a current date/time falls within one or more predetermined windows within which the computing device should not enter the sleep mode; and
if so, indicate to the operating system an objection to entering the sleep mode.

8. The computing device of claim 7, further comprising:
a user interface through which a human user may define the one or more predetermined windows.

9. Program code embodied in storage or transmission media that, when executed on a computing device, causes the computing device to perform a method of controlling power management mode transitions in the computing device, the method comprising:
storing a definition of one or more date/time windows during which the computing device may not enter a sleep mode;
upon a request for entry into the sleep mode, determining whether a current date/time falls within any of the windows; and
if so, denying or suppressing the request; but
if not, entering the sleep mode.

10. The program code of claim 9, wherein:
storing the definition of the one or more date/time windows comprises presenting a user interface though which a human user may indicate the date/time windows.
